(19) United States
(12) Patent Application Publication
(10) Pub. No.: US 2019/0340568 A1
(43) Pub. Date: Nov. 7, 2019

(54) INVENTORY TRACKING VIA WEARABLE DEVICE

(71) Applicant: Microsoft Technology Licensing, LLC, Redmond, WA (US)

(72) Inventors: Kenneth Liam KIEMELE, Redmond, WA (US); Donna Katherine LONG, Redmond, WA (US); Adolfo HERNANDEZ SANTISTEBAN, Bothell, WA (US); Nir FINKELSTEIN, Redmond, WA (US); Bryant Daniel HAWTHORNE, Duvall, WA (US); Jamie R. CABACCANG, Bellevue, WA (US); John Benjamin HESKETH, Kirkland, WA (US); Jennifer Jean CHOI, Seattle, WA (US); Andrew Austin JACKSON, Bellevue, WA (US); Mario Alberto Garcia VERDUZCO, Issaquah, WA (US); John Paul DECUIRE, Redmond, WA (US)

(73) Assignee: Microsoft Technology Licensing, LLC, Redmond, WA (US)

(21) Appl. No.: 16/022,176

(22) Filed: Jun. 28, 2018

Related U.S. Application Data
(60) Provisional application No. 62/667,338, filed on May 4, 2018.

(51) Int. Cl. G06Q 10/08; G10L 15/22

(52) U.S. Cl. CPC G06Q 10/087; H04W 4/80; G10L 15/22

(57) ABSTRACT

Examples are disclosed that relate to conducting inventory management via wearable devices. One example provides a wearable device comprising a communication subsystem, one or more sensors, a logic subsystem, and a storage subsystem comprising instructions executable by the logic subsystem to receive an input activating the wearable device, receive via a sensor of the one or more sensors an input of information regarding a mark-out to make to inventory, provide an output confirming that the input of information was sensed, and send the information regarding the mark-out to make to inventory to an external computing device.

### CROSS REFERENCE TO RELATED APPLICATIONS

This application claims priority to U.S. Provisional Patent Application Ser. No. 62/667,338, filed May 4, 2018, the entirety of which is incorporated by reference for all purposes.

### BACKGROUND

Inventory management involves tracking the movement of raw materials and products into and out of an entity. Inventory tracking may involve adding raw material and/or items for sale to inventory at receiving, adjusting raw material and finished product inventories at product manufacturing, and reducing inventory upon the sale of products.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to conducting inventory management via wearable devices. One example provides a wearable device comprising a communication subsystem, one or more sensors, a logic subsystem, and a storage subsystem comprising instructions executable by the logic subsystem to receive an input activating the wearable device, receive, via a sensor of the one or more sensors, an input of information regarding a mark-out to make to inventory, provide an output confirming that the input of information was sensed, and send the information regarding the mark-out to make to inventory to an external computing device.

### BRIEF DESCRIPTION OF THE DRAWINGS

FIG. 1 shows example wearable devices in the form of electronically functional nametags and illustrates example inventory tracking use scenarios.

FIG. 2 shows an example electronically functional nametag.

FIG. 3 shows an example wearable device in the form of an electronically functional receptacle for a user identification badge.

FIG. 4 shows another example inventory tracking use scenario.

FIG. 5 shows a block diagram illustrating an example system for tracking inventory via wearable devices.

FIG. 6 shows a flowchart illustrating an example method for making a mark-out to inventory via a wearable device.

FIG. 7 shows a flowchart illustrating an example method of updating an inventory record via speech input sensed by a wearable device.

FIG. 8 shows a block diagram illustrating an example computing system.

### DETAILED DESCRIPTION

As described above, inventory tracking involves tracking the movement of raw materials and products into and out of a business. The inflow of materials and products is tracked during receiving, while the outflow is tracked, for example, via sales data and write-offs of expired/unusable materials/products. However, accurately tracking inventory may pose various challenges, as some removals of items from inventory may not be well-tracked. For example, a food service establishment may replace a spilled drink or a dropped food item for no charge, or remake an order to a customer's liking. Such inventory deducted from available supply but not recorded as a sale is referred to herein as a mark-out. An incident leading to a mark-out may happen in the moment, and an employee may be too busy or otherwise neglect to accurately record the mark-out for inventory tracking purposes. Mark-outs that are not recorded by employees are difficult to distinguish from thefts and the like when reviewing inventory records. Thus, it can be difficult for a business to accurately track product loss arising from such sources, and difficult to understand what remedial measures may be best. Further, existing solutions for inventory management often use different hardware for receiving/inventory tracking and point of sale, thereby requiring the business to purchase dedicated hardware for each, at possibly considerable expense.

One possible solution to such issues may be to use a voice-controlled computing device, such as a smart speaker, for an employee to use to verbally enter a mark-out when the mark-out incident occurs. Such a voice-controlled device also may be used for other inventory tracking, such as performing receiving and updating floor inventory counts. However, employee interactions with such a device may be inconvenient and somewhat disruptive to the customer experience, depending upon the location of the employee compared to the smart speaker location and customer locations. Further, persons other than intended users may tamper with the device via speech inputs.

Accordingly, examples are disclosed that relate to inconspicuous wearable devices that are electronically functionalized to assist in tracking inventory. The term “inconspicuous” as used herein refers to the functional nature of the wearable device not being readily noticeable to nearby persons. As an example, the wearable device may take the form of an item normally worn by an employee at a place of business, such as an employee nametag. Thus, while wearing the wearable device, a user may go about normal activities and actions throughout the day without drawing attention to the wearable device. In this manner, the inconspicuous wearable device may not detract from ordinary interpersonal interactions.

An inconspicuous wearable device may take any suitable form. For example, in addition to the above-mentioned nametag, an inconspicuous wearable device also may take the form of an item of jewelry such as a necklace or earring, headwear (e.g. a hat with a company logo), or any other suitable repurposed analog object configured to be worn by a user. By incorporating electronic functionality into an existing analog object that is ordinarily worn in such a setting, the disclosed examples may have a higher adoption rate compared to devices that the user would not normally wear and/or use as part of his or her job. Further, a wearable device may be configured to be sharable among users, such that a wearable device may be used by different users on different days/shifts. This may help to reduce implementation costs, as there is no need to purchase a wearable device for each employee.

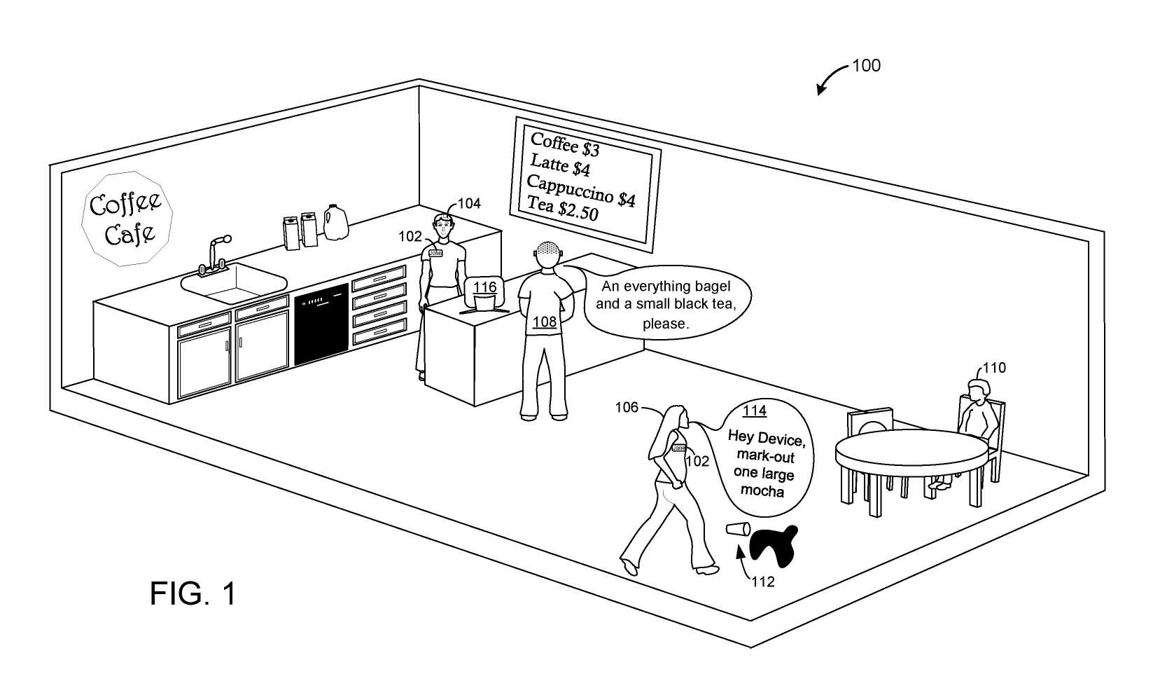

FIG. 1 depicts an example use scenario 100 for tracking inventory using wearable devices, depicted here as electronically functional nametags. Users 104 and 106 are employees of a coffee café and each wears a wearable device 102 in a location where they would customarily wear a nametag without electronic functionality. In this example, a first customer 110 awaits delivery of his drink order. While carrying the drink 112 to the customer 110, user 106 drops the drink 112. In response to dropping the drink, user 106 activates the wearable tag 102 (e.g., via a button or other activation mechanism) and records the mark-out by saying “Hey Device, mark-out one large mocha.” The wearable device 102 receives the input and provides the input to an inventory management computing system for recording the mark-out. Further, the wearable device 102 may provide a positive confirmation of detection of the speech input to user 106, for example, by emitting audio, haptic, and/or light feedback via one or more output devices of the wearable device 102. The positive confirmation may encourage continued use and increase user confidence in the technology, and thus may be output regardless of whether the input is understood by the inventory management computing system, to encourage use of the device.

In this example, user 106 is described as both pressing a button to activate the wearable device 102 and uttering the phrase “Hey Device,” prior to entering the inventory mark-out command. The use of a button press to initiate a user input may help prevent customers or other people from speaking to the wearable device and entering unwanted/incorrect commands. Further, as the button press is used for activation, the “Hey Device” utterance may have no command effect on the device, but instead serve as a social cue. As more detail, because the electronic functionality of the wearable device 102 is inconspicuous, customers may not understand that user 106 is entering a computing device command via speech. As such, by prefacing the command with the “Hey Device” utterance, which is similar to commands used by personal digital assistants as wake phrases, user 106 may signal that he or she is not speaking to others nearby, but rather to a device. Further, the use of such a preface phrase may help with speech recognition, as it may reduce a risk that the intended command is not fully recorded (e.g. any recording lag will not miss the actual command, but only a portion of the preface phrase). While the example of FIG. 1 uses a formal command structure to input the inventory mark-out command, a wearable device also may be configured to detect a signal from ordinary speech (e.g., an exclamatory phrase upon dropping the drink 112) via natural language processing, in other examples.

In some examples, the wearable devices may not be associated with specific users. As such, inventory tracking inputs are not attributed to specific users in those examples. In other examples, some form of user authentication or association may be used to allow specific inventory tracking inputs to be attributed to specific users. In either instance, a user also may have the ability to enter additional information besides the nature of the mark-out, such as an additional speech input comprising an explanation of the mark-out to be stored as an annotation to the mark-out (e.g. explaining that a customer wanted an item remade, an item was dropped, etc.).

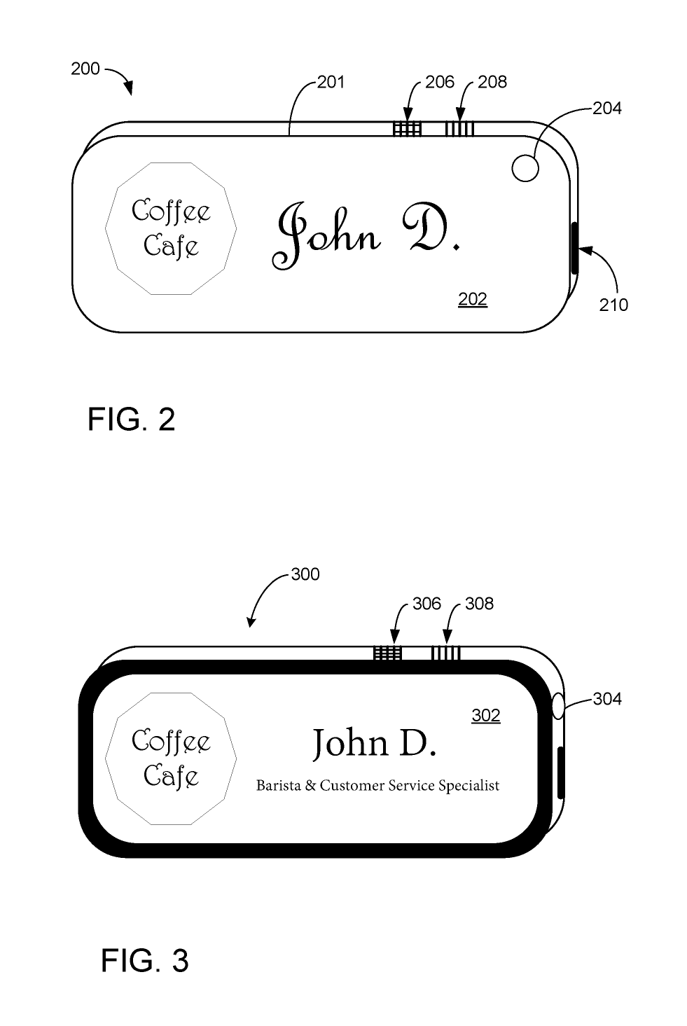

FIG. 2 shows an example electronically functional nametag 200 suitable for use as wearable device 102 of FIG. 1. The depicted nametag 200 includes a body 201 having an erasable or otherwise reusable surface 202 on which an employee may write his or her name, draw an image, or otherwise express his or her identity and personality. The body 201 of the nametag 200 may be waterproof and/or washable, for example, to clean between uses, erase a name written on the nametag, etc. Nametag 200 further comprises an activation mechanism 204 usable to activate the nametag for an inventory tracking input. In the example of FIG. 2, the nametag 200 includes a button 204 that can be pressed to initiate an inventory tracking input. In other examples, other activation mechanisms may be used, such as a capacitive touch sensor, thermal sensor, resistive touch sensor, and/or image sensor. In yet other examples, a verbal wake phrase may be used to activate the nametag 200 for an inventory tracking input.

The nametag 200 further comprises a microphone 206 for receiving voice inputs. The microphone 206 may be directional to reduce noise received from directions other than toward a user's mouth, and to lessen the risk of customers intentionally or incidentally making unwanted speech commands to the nametag 200. In some examples, the nametag 200 may include an additional microphone configured to detect ambient sounds for use in noise cancellation. The nametag 200 also may include other suitable input devices, as described in more detail below.

The nametag 200 further may comprise various output devices. In the depicted example, the nametag 200 comprises a directional speaker 208 to enable the nametag 200 to output sounds that are audible to a wearer but less perceptible to bystanders. The nametag also may include other output devices, such as one or more of a light, a display, and a haptic device.

The nametag 200 further includes one or more batteries configured to contain sufficient charge for a desired use duration (e.g., the workday or shift), and a charging port 210 for connecting the nametag to a power supply for charging between uses. In other examples, the nametag 200 may be configured to charge the one or more batteries wirelessly via inductive charging. The use of a button push to activate the nametag 200 for receiving a speech input allows the nametag 200 to remain in a relatively inactive state until receipt of an activation input, and thus helps to preserve battery life compared to devices that are constantly “awake” and listening for a known command.

FIG. 3 depicts another example wearable device in the form of an electronically functional receptacle 300 for holding an identification badge 302. In this example, an existing nametag or other suitable identification badge may be inserted into the receptacle 300 (e.g., via a slot along one end of the receptacle) to resemble a conventional nametag or lanyard. The receptacle 300 may operate similarly to, and include similar input and output devices to, nametag 200. In some examples, a wearable device may also comprise a code reader configured to read a machine-readable user identifier (e.g., an optical code, RFID tag, and/or other suitable machine-readable identifier), such as a machine-readable user identifier embedded in an identification badge. In this manner, a wearable device may authenticate and/or associate a specific user with the wearable device to allow specific inventory tracking inputs to be attributed to the specific user.

Returning to FIG. 1, in addition to tracking mark-outs, the wearable device 102 may be used in association with, or as an alternative to, a conventional point of sale system. User 104 is operating a point of sale system 116 as a second customer 108 places an order for an everything bagel and a small black tea. The wearable device 102 receives the conversational speech input and provides it to an inventory tracking computing system. The inventory tracking computing system then detects the input “everything bagel” and “black tea” as inventory items and detects the input “small” as a size modifier for “black tea.” In other examples, speech recognition processing may occur locally on the wearable device 102. In either example, the ordered items then may be deducted from the café's available inventory supply.

In this example, the recognized items also may be provided to a point of sale system to assist in effecting the purchase transaction, such that the wearable device acts as a speech input system for the point of sale system. The point of sale system may be configured to output to a display the input received by the wearable device, thereby providing the user and the customer the opportunity to modify and/or approve the sensed sale input. The wearable device 102 may communicate with the point of sale system in any suitable manner, such as via Bluetooth or another suitable communication channel. In this manner, the user may more easily maintain eye contact and interact conversationally with the customer 108.

A wearable device may also be used to record voice notes and/or reminders to be played at another time to the user or another user. In FIG. 1, user 106 may be cleaning up the spilled drink 112 and realize that only one roll of paper towels remains in the store's supply cabinet. Rather than abandon the spilled drink 112 to write down a reminder to order more paper towels, user 106 may activate the wearable device 102 and record a note regarding the low supply of paper towels. At a later time, the wearable device 102 may provide the output to remind the user of the low supply of paper towels. The reminder may be output (e.g. as recorded audio) at a fixed time after the reminder is input, based upon a detected change in context (e.g. sensing that the user is in a workplace breakroom and not in a customer service area), or upon any other suitable trigger.

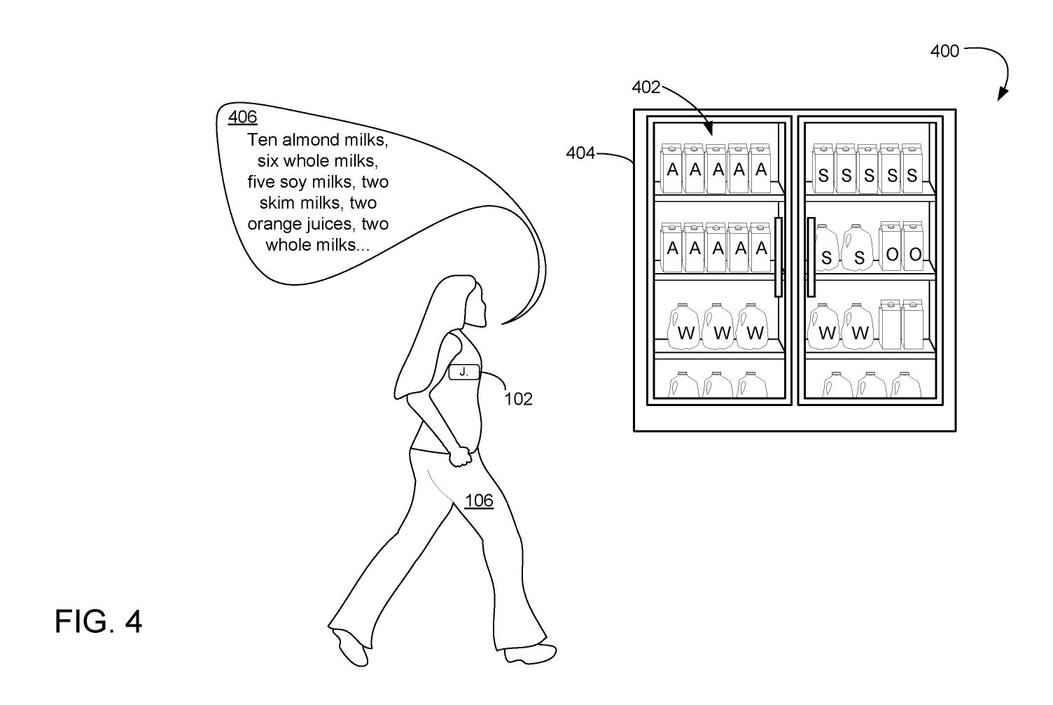

FIG. 4 depicts another example use scenario 400 in which an inconspicuous wearable device may be used for inventory tracking tasks. In this example, user 106 is receiving inventory 402 that was delivered and placed into a refrigerator 404. While visually inspecting the inventory 402, user 106 activates the wearable device 102 and speaks conversationally regarding the inventory 402. The wearable device 102 may be set to a dedicated receiving mode by user input (e.g. a speech command specifying that receiving is being performed), the receiving mode may be set automatically based upon detecting contextual information related to receiving (e.g. by detecting that the device is in a receiving area via Bluetooth, Wi-Fi, RFID, or other communication connections with nearby devices in a receiving area of the workplace), or the wearable device may forward the voice commands to a computing system that understands the context of the commands from the wording of the commands. In this example, to enter the items into inventory, the employee merely speaks a list of items that were delivered, and the speech input received by the wearable device 102 is used to update inventory records for the business. In this example, user 106 recites “six whole milks” and then later recites “two whole milks”. In such instances, the inventory system may determine that the inventory shipment 402 included eight whole milks, potentially by checking against order records to disambiguate the input. Further, the wearable device and/or a computer system receiving data from the wearable device additionally or alternatively may be configured to perform object recognition via an integrated image sensor to track inventory, for example by determining how many of each item are in the refrigerator from the image data. Such image data also may be used to confirm received voice inputs, in some instances.

A wearable device further may be used to automatically add items to an order list. For example, a user may become aware that inventory for an item is low, and in response activate the wearable device (e.g., via button press or other suitable activation mechanism) and verbally enter an order for the item. The order then may be forwarded to a financial/purchasing manager for approval. As another example, an inventory system may, upon receiving a verbal inventory count for an item, determine that the inventory count is below a threshold number, and automatically create an order.

In some examples, sensor information from a wearable device may be used to locate the wearable device in an environment and store the location with an inventory tracking input. Such a location determination may be performed locally on the wearable device, or remotely on a computing system that receives information from the wearable device. Any suitable data may be used to locate a wearable device an environment. As one example, a wearable device may include one or more infrared light-emitting diodes detectable by cameras in the work environment. As another example, a location may be determined based on wireless network connections (e.g. Bluetooth or Wi-Fi data), via global positioning system (GPS) data, and/or via image data from an integrated image sensor of the wearable device that captures image data of known markers within the use environment. As yet another example, a wearable device may include an ultrasonic transmitter and an ultrasonic receiver to generate and receive reflections of sound waves in the ultrasonic range, or to provide sound waves to and receive sound waves from other ultrasonic transmitter/receivers in the environment.

Information regarding the location of the wearable device at the time of an inventory tracking input may be used, for example, to identify workplace inefficiencies and/or track performance metrics. As one example, information regarding a location in a physical environment at which food and drink items are often dropped (as determined from mark-out inputs) may be used to identify a bottleneck in workflow, e.g. where employees collide while going between a kitchen or order counter and particular tables. Such information may inform a decision to rearrange furniture or take other corrective action.

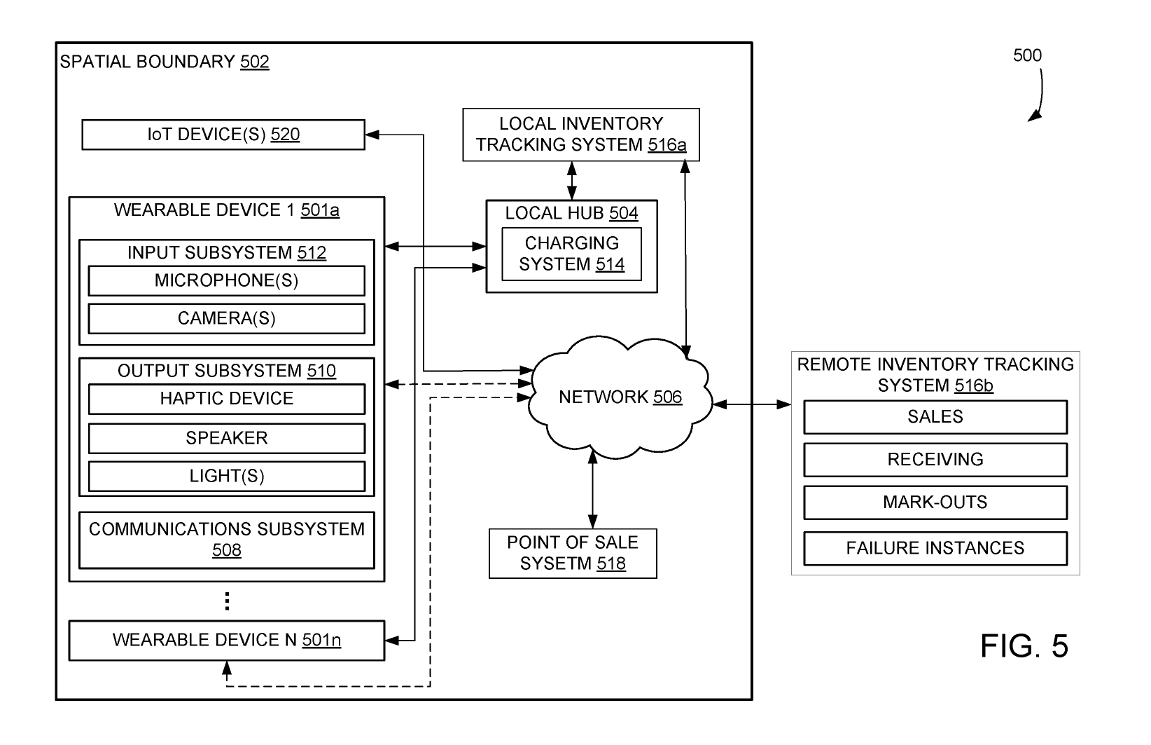

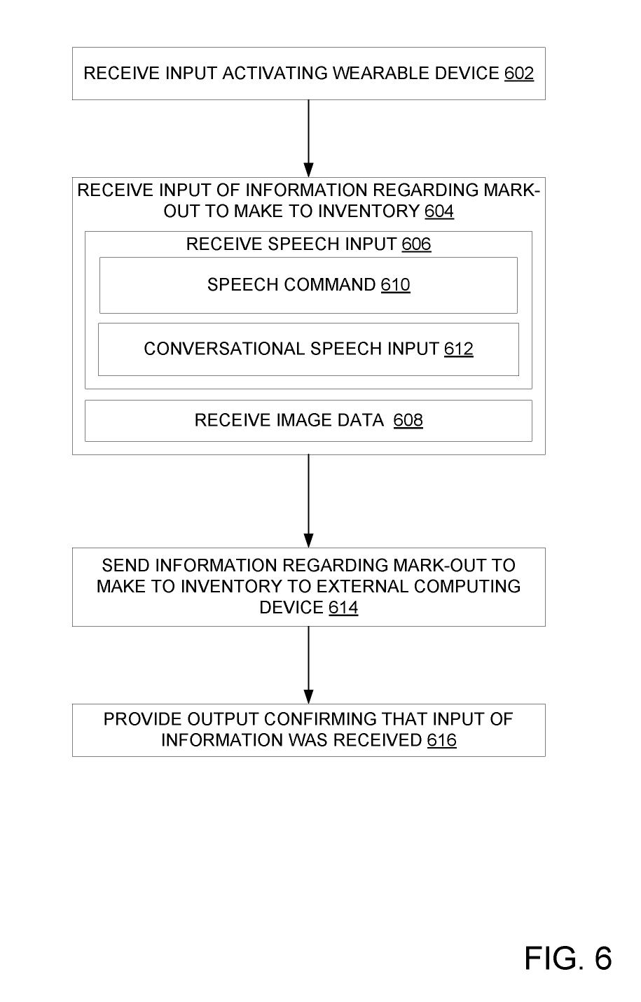

FIG. 5 depicts an example system 500 for tracking inventory using one or more wearable devices 501a through 501n. The system 500 is configured to operate within a spatial boundary 502 defining a physical environment in which one or more wearable devices (shown as wearable devices 1 through N) may be used. The term “spatial boundary” refers to a place of work, such as a jobsite, a physical store location, a warehouse, an office, etc., and in some cases may not correspond to an actual physical boundary, but rather to a communication range of devices operating in the workspace.

Within the physical environment, one or more wearable devices (shown as device 1 through device N) communicate, via a communication subsystem 508 of each wearable device, with various other computing systems over a wireless local- or wide-area network 506. Such communication may be directly with the computing system via network 506 (as shown in dashed lines), or via a local communication hub 504 (e.g. a charging station/hub for the wearable devices), as shown in solid lines. Example communication protocols include Bluetooth, Wi-Fi, RFID, and ultrasonic transmission.

Wearable devices 1 through N each comprise an output subsystem 510. The wearable devices each may include any suitable output device, such as one or more haptic device(s), speaker(s), and light(s). In some examples, the wearable devices 1 through N each include a directional speaker to reduce likelihood nearby persons will hear messages intended for the wearer.

Each wearable device 1 through N further may comprise an input subsystem 512 including one or more input devices. As one example, the wearable devices 1 through N each may comprise a microphone configured to receive user voice input. The microphone may be a directional microphone (e.g., positioned upwards towards the mouth) to help reduce ambient noise and avoid inadvertent or incidental speech inputs arising from ambient speech (e.g. customers talking to one another). A wearable device also may comprise a microphone oriented to capture ambient sounds for noise cancellation. As other examples, the wearable devices 1 through N may include one or more image sensor(s), touch sensor(s), fingerprint sensor(s), and/or thermal sensor(s).

Each wearable device 1 through N may include other components not shown in FIG. 5. For example, each wearable device comprises a power supply, such as one or more rechargeable batteries. System 500 is depicted as including a charging system 514 in a local hub device for docking wearable devices not currently being used, but a charging system also may be implemented separately from such a hub.

As mentioned above, each wearable device may communicate with a computing system that maintains inventory records, as well as other computing systems such as point of sale systems. Such computing systems may be local to the physical environment, and/or located remotely (e.g. hosted in a cloud-based computing system). As such, FIG. 5 illustrates a local inventory tracking computing system 516a and a remote inventory tracking system 516b. As illustrated at 516b, each of these computing system(s) may store various inventory-related data, such as sales data, receiving data, and mark-out data. In some examples, location data may be stored for mark-out incidents and/or other data. Additionally, information may be stored regarding when a wearable device failed to correctly sense an intended input. Such data may be analyzed by a manager, system administrator, and/or suitable logic device to determine usability and performance improvements for the system. As another example computing system, a point of sale system is illustrated at 518.

The system 500 further comprises one or more Internet of Things (IoT) devices 520 that communicate with other computing devices of system 500. Example devices 520 include appliances, machinery, and locks to access-restricted locations. Such devices may help to locate wearable devices 1 through N in the physical environment, as described above.

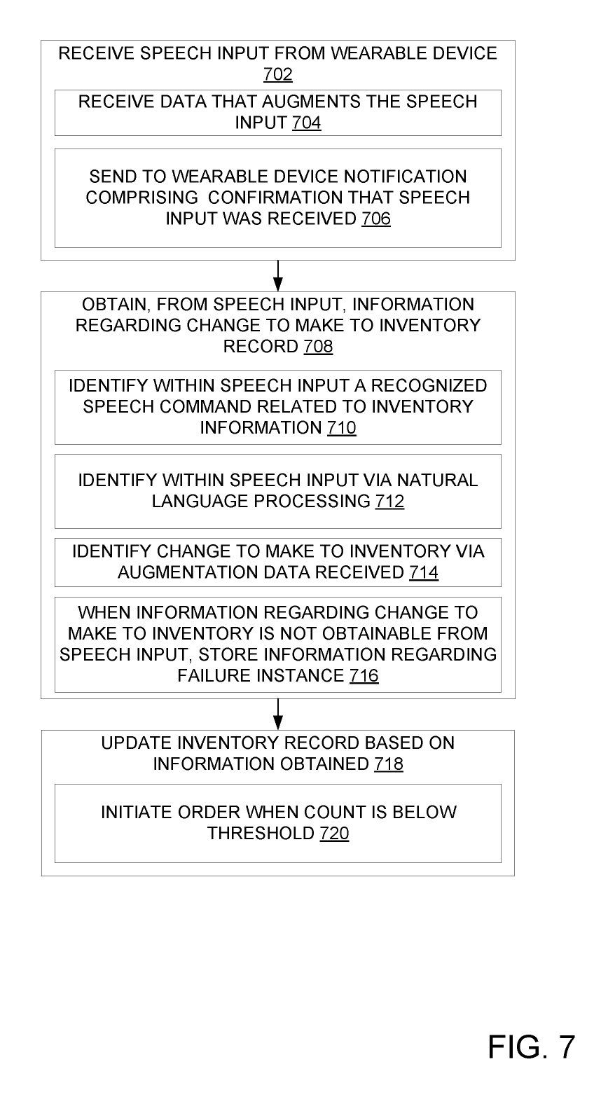

FIG. 6 shows a flowchart illustrating an example method 600 for receiving an inventory mark-out via a wearable device. Method 600 may be implemented as stored instructions executable by a logic subsystem of a wearable device, such as wearable devices 102, 200, 300 and 501a through 501n. At 602, method 600 comprises receiving an input activating the wearable device. Any suitable type of input may be used to activate the wearable device, including a button press or other suitable mechanical input, or a touch input sensed by a touch sensor. As described above, the wearable device may remain in a relatively inactive state until receipt of such an activation input, which may help to preserve battery life compared to devices that are constantly “awake” and listening for a known command. In other examples, a wake phrase input via speech received by a microphone may be used to activate the wearable device. Further, in some examples, the wearable device may be associated with a particular user during a use session. Such association with a particular user allows actions taken via the wearable device during that use session to be associated with that user.

After the wearable device is activated, method 600 comprises, at 604, receiving, via one or more sensors, an input of information regarding a mark-out to make to inventory. The information may be received via any suitable input mechanism. Examples include speech inputs 606 and image data 608 (e.g. as received from a local image sensor or an image sensor external to the wearable device in communication with the wearable device). The voice input 606 may comprise a dedicated speech command 610 designating the input as a mark-out, and/or may comprise a conversational speech input 612 that may be analyzed using natural language processing. The term conversational speech input as used herein refers to speech input that lacks the formal sentence structure and/or a key phrase(s) used for issuing a command. For example, rather than the command “Hey Device, mark-out one large mocha,” described by example in FIG. 1, a conversational speech input may take the form of the user 106 speaking conversationally about spilling the drink, without the use of key phrases or formal command structure.

Method 600 further comprises, at 614, sending the information regarding the mark-out to make to inventory to an external computing device (e.g. via Bluetooth, Wi-Fi, RFID, ultrasonic transmission, or other suitable communication method). In this manner, the user may record the mark-out at the moment the mark-out incident occurs with little effort. This may encourage use of the wearable device to record mark-out incidents, and thus improve the accuracy of inventory records. This also may permit updating of the inventory record without substantially distracting the user from a current task, and thus may help improve productivity.

At 616, method 600 comprises providing an output confirming that the input of information was sensed. The wearable device may output the notification regardless of whether the input of information regarding the mark-out to make to inventory was properly sensed. This may encourage continued reporting of inventory mark-outs via the wearable device without burdening a user to problem-shoot regarding inputs that are not correctly sensed and/or understood. Any suitable output mechanism may be used. Examples include a haptic actuator, a speaker, a light, and/or a display. In some examples, the wearable device may locally trigger the output confirming that the input of information was sensed, for example, by detecting a cessation of speech for a threshold duration and providing the output in response. In other examples, the wearable device may receive, from the external computing device to which the input of information was sent, a notification that the input of information was received (whether or not the information was understood). It will be understood that a wearable device may be used to track other types of inventory changes by speech input in addition to mark-outs, such as new inventory received and sales of existing inventory.

FIG. 7 is a flowchart illustrating an example method 700 for updating an inventory record based on a speech input recorded by a wearable device. Method 700 may be implemented as stored instructions executable by a computing system in communication with one or more wearable computing systems. Examples include inventory tracking systems 516a and 516b, and hub 504. At 702, method 700 comprises receiving, from a wearable device, a speech input (e.g. via Bluetooth, Wi-Fi, RFID, ultrasonic transmission, or other suitable mechanism). In some examples, method 700 further comprises receiving data that augments the speech input 704, such as image data (e.g., from a wearable device and/or an image sensor(s) external to the wearable device), location data, and time data. Upon receipt of speech input, method 700 may comprise, in some examples, sending to the wearable device a notification for output by the wearable device 706, wherein the notification comprises a confirmation that the speech input was received. Such a notification may be sent to the wearable device regardless of whether the speech input was correctly sensed and/or understood, which may help to encourage continued reporting of inventory incidents. In other examples, such a notification may be triggered and performed on the wearable device.

At 708, method 700 comprises obtaining from the speech input information regarding a change to make to an inventory record. Obtaining the information regarding the change to make to the inventory record may comprise, at 710, using a speech recognizer to identify within the speech input a recognized speech command related to inventory information, such as an identification of an inventory item to adjust, a quantity, and an action (e.g. receive, mark-out, sale, etc.). Obtaining the information also may comprise, at 712, identifying speech related to inventory adjustment using natural language processing to identify a probable input of information related to a change to make to the inventory record. In some examples, other information may be used to augment a speech command related to inventory record changes, as indicated at 714. For example, location information (e.g. as determined by location sensors such as global positioning sensors, ultrasonic chirp, short-range wireless communication devices, etc.) may help to disambiguate inventory information. As a more specific example, a subtraction from inventory performed in a location determined to correspond to receiving may be handled differently (e.g. recorded as a return to manufacturer) compared to a subtraction performed on a retail floor (which may be recorded as a mark-out). As another example, object recognition using image data may be used to augment a speech command. In such examples, object recognition may be used to corroborate or disambiguate a speech input regarding a change to make to an inventory record.

As mentioned above, at times a wearable device may not properly sense and/or record a speech input, or the speech input may not be understood properly by a speech recognizer that is used to extract inventory commands from speech inputs. Storing information regarding such failures may allow follow-up actions to be performed, such as conducting a follow-up discussion with users to learn more information on what inventory event was not properly understood (and thereby manually record the proper adjustment to make), training users to better operate the wearable devices, and/or modifying the operation of wearable devices or system/workflow of the entity. Thus, at 716, method 700 may comprise storing information regarding a failure instance. Any suitable information may be stored, such as an identity of a device from which the input was received, a time of the input, and a location of the input (if location data is available).

Continuing, at 718, method 700 comprises updating the inventory record based on the information obtained. Updating the inventory record may comprise updating the inventory record to reflect a mark-out, a sale of existing inventory, receiving of new inventory, and/or any other suitable change to make to the inventory record. Other data also may be stored, such as a location at which a mark-out occurred, information regarding an identity of a user and/or wearable device from which an inventory change command was received, time information, etc. Inventory information tracked as described above may be used in other ways to help improve business efficiencies. For example, as shown at 720, an inventory tracking system may initiate a new item order when a count of an inventory item drops below a threshold count. Initiating a new order may comprise, for example, creating an order form for approval by an appropriate user, sending a reminder to an appropriate user regarding the low count, and/or any other suitable actions.

In some embodiments, the methods and processes described herein may be tied to a computing system of one or more computing devices. In particular, such methods and processes may be implemented as a computer-application program or service, an application-programming interface (API), a library, and/or other computer-program product.

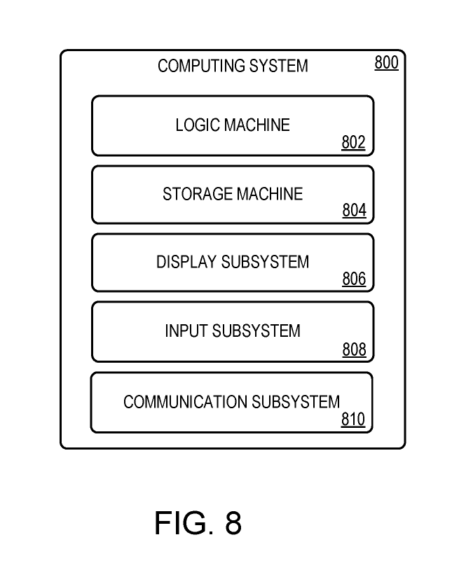

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine 802 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 802 may include one or more processors configured to execute software instructions. Additionally or alternatively, the logic machine 802 may include one or more hardware or firmware logic machines configured to execute hardware or firmware instructions. Processors of the logic machine 802 may be single-core or multi-core, and the instructions executed thereon may be configured for sequential, parallel, and/or distributed processing. Individual components of the logic machine 802 optionally may be distributed among two or more separate devices, which may be remotely located and/or configured for coordinated processing. Aspects of the logic machine 802 may be virtualized and executed by remotely accessible, networked computing devices configured in a cloud-computing configuration.

Storage machine 804 includes one or more physical devices configured to hold instructions executable by the logic machine 802 to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program,” may be used to describe an aspect of computing system 800 implemented to perform a particular function. In some cases, a program may be instantiated via logic machine 802 executing instructions held by storage machine 804. It will be understood that different programs may be instantiated from the same application, service, code block, object, library, routine, API, function, etc. Likewise, the same program may be instantiated by different applications, services, code blocks, objects, routines, APIs, functions, etc. The term “program,” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, a wired or wireless local- or wide-area network, or acoustically via an ultrasonic transmitter/receiver. In some embodiments, the communication subsystem may allow computing system 800 to send and/or receive messages to and/or from other devices via a network such as the Internet.

Another example provides a wearable device, comprising a communication subsystem, one or more sensors, a logic subsystem, and a storage subsystem comprising instructions executable by the logic subsystem to receive an input activating the wearable device, receive, via a sensor of the one or more sensors, an input of information regarding a mark-out to make to inventory, provide an output confirming that the input of information was sensed, and send the information regarding the mark-out to make to inventory to an external computing device. In such an example, the one or more sensors may additionally or alternatively comprise one or more of an image sensor, a touch sensor, a microphone, and/or a thermal sensor. In such an example, the microphone may additionally or alternatively comprise a directional microphone. In such an example, the instructions may additionally or alternatively be executable to receive a voice input of information regarding the mark-out. In such an example, the instructions may additionally or alternatively be executable to detect a voice command as the voice input. In such an example, the input of information may additionally or alternatively comprise conversational speech input. In such an example, the wearable device may additionally or alternatively comprise an output subsystem comprising one or more of a speaker, a haptic device, a display, and/or a light. In such an example, the speaker may additionally or alternatively comprise a directional speaker. In such an example, the instructions may additionally or alternatively be executable to send the information regarding the mark-out via one or more of Bluetooth, Wi-Fi, RFID, near-field communication (NFC), and/or ultrasonic transmission. In such an example, the wearable device may additionally or alternatively comprise one or more of an article of jewelry, a receptacle for a machine-readable user identifier, a nametag, a hat, and/or a visor.

Another example provides a system, comprising a logic subsystem, and a storage subsystem comprising instructions executable by the logic subsystem to receive, from a wearable device, a speech input, obtain, based at least on the speech input, information regarding a change to make to an inventory record, and update the inventory record based on the information obtained. In such an example, the instructions may additionally or alternatively be executable to store information regarding a failure to obtain from the speech input the information regarding the change to make to the inventory record. In such an example, the instructions may additionally or alternatively be executable to receive image data augmenting the speech input. In such an example, the instructions may additionally or alternatively be executable to perform object recognition on the image data received, and to augment the speech input based on the object recognition. In such an example, the information regarding the change to make to the inventory record may additionally or alternatively comprise one or more of an inventory item identification, a quantity, and an action to take to change the inventory record. In such an example, the instructions may additionally or alternatively be executable to, based at least on the information obtained, determine that an inventory count is below a threshold count and initiate a new inventory order. In such an example, the instructions may additionally or alternatively be executable to augment the speech input based upon location data received. In such an example, the instructions may additionally or alternatively be executable to send to the wearable device a notification for output by the wearable device, the notification comprising a positive confirmation that the speech input was sensed.

Another example provides a method for tracking mark-outs to make to inventory via a wearable device comprising one or more sensors, the method comprising receiving an input activating the wearable device, receiving, via a sensor of the one or more sensors, an input of information regarding a mark-out to make to inventory, providing an output confirming that the input of information was sensed, and sending the information regarding the mark-out to make to inventory to an external computing device. In such an example, receiving the input of information regarding the mark-out to make to inventory may additionally or alternatively comprise receiving the information via one or more of a microphone and an image sensor.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device, comprising:
a communication subsystem;
one or more sensors,
a logic subsystem; and
a storage subsystem comprising instructions executable by the logic subsystem to
receive an input activating the wearable device,
receive, via a sensor of the one or more sensors, an input of information regarding a mark-out to make to inventory,
provide an output confirming that the input of information was sensed, and
send the information regarding the mark-out to make to inventory to an external computing device.

2. The wearable device of claim 1, wherein the one or more sensors comprises one or more of an image sensor, a touch sensor, a microphone, and/or a thermal sensor.

3. The wearable device of claim 2, wherein the microphone comprises a directional microphone.

4. The wearable device of claim 1, wherein the instructions are executable to receive a voice input of information regarding the mark-out.

5. The wearable device of claim 4, wherein the instructions are executable to detect a voice command as the voice input.

6. The wearable device of claim 4, wherein the input of information comprises conversational speech input.

7. The wearable device of claim 1, further comprising an output subsystem comprising one or more of a speaker, a haptic device, a display, and/or a light.

8. The wearable device of claim 7, wherein the speaker comprises a directional speaker.

9. The wearable device of claim 1, wherein the instructions are executable to send the information regarding the mark-out via one or more of Bluetooth, Wi-Fi, RFID, near-field communication (NFC), and/or ultrasonic transmission.

10. The wearable device of claim 1, wherein the wearable device comprises one or more of an article of jewelry, a receptacle for a machine-readable user identifier, a nametag, a hat, and/or a visor.

11. A system, comprising:
a logic subsystem; and
a storage subsystem comprising instructions executable by the logic subsystem to
receive, from a wearable device, a speech input,
obtain, based at least on the speech input, information regarding a change to make to an inventory record, and
update the inventory record based on the information obtained.

12. The system of claim 11, wherein the instructions are further executable to store information regarding a failure to obtain from the speech input the information regarding the change to make to the inventory record.

13. The system of claim 11, wherein the instructions are further executable to receive image data augmenting the speech input.

14. The system of claim 13, wherein the instructions are executable to perform object recognition on the image data received, and to augment the speech input based on the object recognition.

15. The system of claim 11, wherein the information regarding the change to make to the inventory record comprises one or more of an inventory item identification, a quantity, and an action to take to change the inventory record.

16. The system of claim 11, wherein the instructions are further executable to, based at least on the information obtained, determine that an inventory count is below a threshold count and initiate a new inventory order.

17. The system of claim 11, wherein the instructions are further executable to augment the speech input based upon location data received.

18. The system of claim 11, wherein the instructions are further executable to send to the wearable device a notification for output by the wearable device, the notification comprising a positive confirmation that the speech input was sensed.

19. A method for tracking mark-outs to make to inventory via a wearable device comprising one or more sensors, the method comprising:
receiving an input activating the wearable device;
receiving, via a sensor of the one or more sensors, an input of information regarding a mark-out to make to inventory;
providing an output confirming that the input of information was sensed; and
sending the information regarding the mark-out to make to inventory to an external computing device.

20. The method of claim 19, wherein receiving the input of information regarding the mark-out to make to inventory comprises receiving the information via one or more of a microphone and an image sensor.
